(19) United States
(12) Patent Application Publication
(10) Pub. No.: US 2026/0000155 A1
(43) Pub. Date: Jan. 1, 2026

(54) BREATHABLE CUSHIONED SHOE, BREATHABLE CUSHIONED SOLE, AND METHOD FOR PREPARING BREATHABLE CUSHIONED SOLE

(71) Applicant: Tinghe GUO, Chengdu, Sichuan (CN)

(72) Inventors: Tinghe GUO, Chengdu, Sichuan (CN); Wanqiang GUO, Chengdu, Sichuan (CN); Haiwen PAN, Chengdu, Sichuan (CN); Jinsheng WU, Chengdu, Sichuan (CN); Heng YIN, Chengdu, Sichuan (CN); Xinye YAO, Chengdu, Sichuan (CN); Songsong LIU, Chengdu, Sichuan (CN)

(21) Appl. No.: 18/850,601

(22) PCT Filed: Jul. 6, 2023
(86) PCT No.: PCT/CN2023/106138

§ 371 Date: Jun. 25, 2025

(30) Foreign Application Priority Data
Oct. 14, 2022 (CN) 202211284265.X

(51) Int. Cl. A43B 13/04; A43B 7/08; A43B 13/12; A43B 13/16; B33Y 30/00; B33Y 80/00; C08J 9/12

(52) U.S. Cl. CPC A43B 13/04; A43B 7/08; A43B 13/125; A43B 13/16; C08J 9/122; B33Y 30/00; B33Y 80/00; C08J 2375/04

(57) ABSTRACT

Provided are a breathable cushioned shoe, breathable cushioned sole, and method for preparing a breathable cushioned sole. The method includes: preparing an outsole; preparing a midsole using a foaming method, where a flange that extends upwardly is formed on the midsole, and a region within the flange is defined as an accommodation region; and the accommodation region includes a fore sole region and a heel region, and a support that extends upwardly is formed in a rear sole region of the midsole; preparing a breathable body using an additive manufacturing method, where the breathable body has breathable channels connected with each other; placing the breathable body in the fore sole region, and connecting the breathable body to the midsole; separately applying glue on an upper surface of the support and an outer periphery of the breathable body; and placing a lasting insole on the breathable body and the support.

### TECHNICAL FIELD

The present disclosure relates to the field of footwear, and in particular to a method for preparing a breathable cushioned sole, a sole prepared using the method for preparing a breathable cushioned sole, and a shoe using the sole.

### BACKGROUND ART

The comfort of shoes is affected by many factors, such as designs of the last, the upper part, and the midsole, materials, and process design. The comfort is manifested in the heel height, the size of the shoes, the weight, breathability, shock absorption, cushioning performance, and stability.

Therefore, the comfort of the shoes needs to be comprehensively evaluated from various objective factors. At present, there are mature implementation solutions for shoes on the market in terms of the size, the weight, and cushioning performance. Breathability of the shoes, especially breathability of the sole, is difficult to achieve due to the limitations of current material technologies.

However, the forefoot and heel of the sole of the foot have a large number of sweat glands, and are main perspiration regions of a human body. Soles of the current footwear products do not have good breathability, and sweat is easy to be gathered when the shoes are worn for a long term, causing foot diseases (for example, tinea pedis, eczema, and fungal infection). This has plagued people with high labor intensity, such as soldiers in training, running athletes, medical personnel, epidemic prevention and control workers, miners, and the like. In addition, from the point of view of regional distribution and seasons, this factor is especially obvious in hot and humid regions and high-temperature seasons. In addition, sweat is not perspired when thermal shoes whose soles are not breathable are worn in winter.

Therefore, soles of shoes generally have poor breathability, and sweat is not easy to be perspired when the shoes are worn for a long term. To improve the comfort of the shoes, there is an urgent need for a more reasonable technical solution, which can enable the soles of the shoes to have high cushioning comfort, take into account cushioning needs of various groups of people, and improve the breathability of sweat gland regions on the sole of the foot.

### SUMMARY

The present disclosure provides a breathable cushioned shoe, a breathable cushioned sole, and a method for preparing a breathable cushioned sole.

To achieve the above effect, the present disclosure adopts the following technical solutions.

A method for preparing a breathable cushioned sole includes:
preparing an outsole;
preparing a midsole using a foaming method, where a flange that extends upwardly is formed on the midsole, a region within the flange is defined as an accommodation region; and the accommodation region includes a fore sole region and a heel region, and a support that extends upwardly is formed in a rear sole region of the midsole;
preparing a breathable body using an additive manufacturing method, where the breathable body has a plurality of breathable channels that are connected with each other;
placing the breathable body in the fore sole region, and connecting the breathable body to the midsole in a mortise-tenon jointing manner;
separately applying glue on an upper surface of the support and an outer periphery of the breathable body; and
placing a lasting insole on the breathable body and the support, to enable the lasting insole to be glued to the breathable body and the support.

In a possible design, the additive manufacturing method includes:
performing profiling design on the breathable body, to obtain a digital model, and designing a running track based on the digital model;
enabling a three-dimensional (3D) printer to run according to the running track, and outputting a material on a substrate layer; and sintering the material, form a support rib through lamination and curing; and
repeating the above operations, to enable the support rib to be cured layer by layer, and form the breathable body.

In a possible design, the material is thermoplastic polyurethane elastomer rubber powders, with a particle size of a micron level.

In a possible design, the sintering is conducted at 80° C. to 180° C.

In a possible design, the foaming method includes:
ejecting, by a foaming machine, a foaming material, to form a polymer sub-blank;
placing the polymer sub-blank into a high pressure reactor;
conducting preheating, injecting a foaming agent, and after gas is diffused and balanced, rapidly releasing pressure to allow for foaming; and
placing a special-shaped part after the forming into a forming mold to allow for forming, to obtain the midsole.

In a possible design, the foaming agent is CO₂, N₂, or He.

In a possible design, the foaming material is at least one of supercritical foaming nylon, thermoplastic polyurethane (TPU), ethyl vinyl acetate (EVA), or polyether block amide (PEBA).

In a possible design, an overall thickness of the breathable cushioned sole is gradually increased along a direction from a fore sole to a heel.

A breathable cushioned sole is prepared using the method for preparing a breathable cushioned sole.

A breathable cushioned shoe includes a breathable cushioned sole prepared using the method for preparing a breathable cushioned sole.

According to the above technical solution, a plurality of lattices that are connected to each other and used for air circulation may be prepared. This is beneficial to breathability and perspiration, as well as heat dissipation. Therefore, the forefoot is refreshing and comfortable, avoiding fungal growth or eczema of the skin due to sweat gathered in the forefoot. In addition, based on the structural design of the lattices, the breathable body has a specific cushioning function. Therefore, impact on the forefoot is reduced when the forefoot hits the ground, thereby helping the forefoot to hit the ground safely and stably.

Further, the support, the breathable body, the midsole, and the outsole may be quickly assembled based on their mortise-tenon jointing. Further, based on features of the mortise-tenon jointing, once specifications of the support, the breathable body, the midsole, and the outsole are not matched with each other, the staff can find and resolve the problem at first time, to avoid unqualified soles from entering a downstream process. This plays a specific role in correcting errors.

### DESCRIPTION OF THE DRAWINGS

In order to more clearly illustrate the technical solutions in the embodiments of the present disclosure, a brief introduction to the accompanying drawings required for the embodiments will be provided below.

FIG. 1 is a schematic diagram of a structure of a breathable body;

FIG. 2 is a schematic diagram of a partial structure of a breathable body in a sole;

FIG. 3 is a schematic diagram of the structure of the sole, where along a direction of the drawing, a region on a left side of a boundary line A is a toe region, and a region between the boundary line A and a boundary line B is a sole region; it should be noted that due to different foot shapes, the toe region and the sole region may be partially overlapped; a region between the boundary line B and a boundary line C is a foot arch region, and a region on a right side of the boundary line C is a heel region; and it should be noted that position marks of the boundary line A, the boundary line B, the boundary line C, and the boundary line D are used for understanding of the present disclosure only;

FIG. 4 is a schematic diagram of a structure of an outsole in a sole;

FIG. 5 is a performance test diagram of TPU powders;

FIG. 6 is a diagram of sphericity of powers when the powders are sintered through a method for preparing a breathable cushioned sole;

FIG. 7 is a diagram of a material when the material is processed through a conventional technology;

FIG. 8 is a sphericity and particle size distribution curve of a material when a breathable body is prepared using a method for preparing a breathable cushioned sole;

FIG. 9 is tensile strength test data of a support rib when a breathable body is prepared using a method for preparing a breathable cushioned sole; and

FIG. 10 is a schematic diagram of a lasting insole.

### REFERENCE NUMERALS

1: outsole; 2: midsole; 3: lasting insole, 4: breathable body; 400: support rib; 5: claw nail.

### SPECIFIC IMPLEMENTATIONS

The present disclosure will be further described below with reference to the accompanying drawings and specific embodiments.

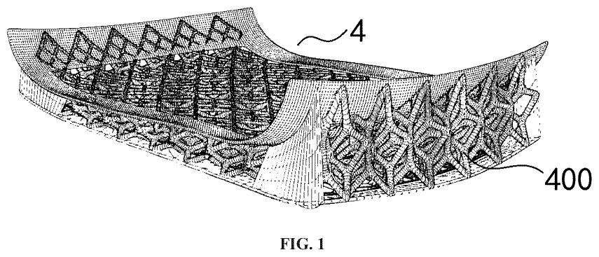

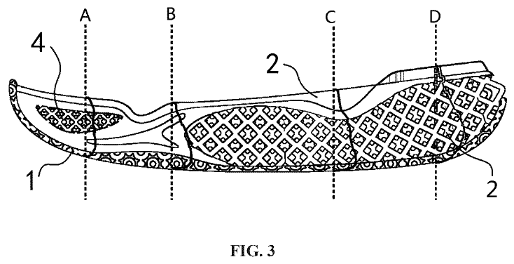

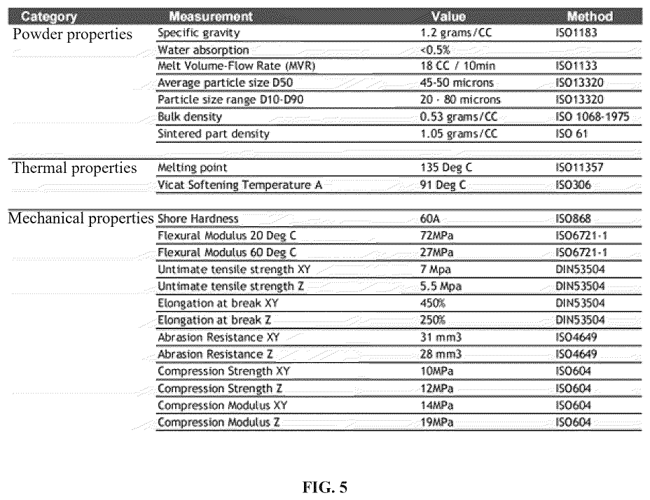

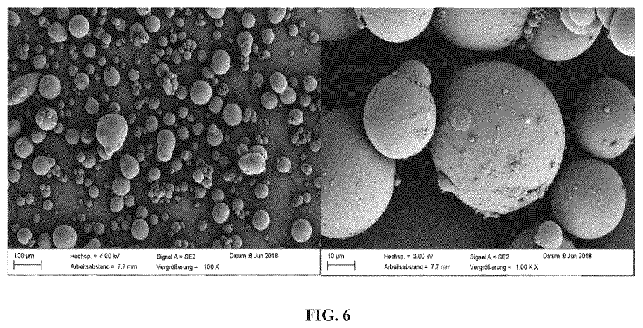

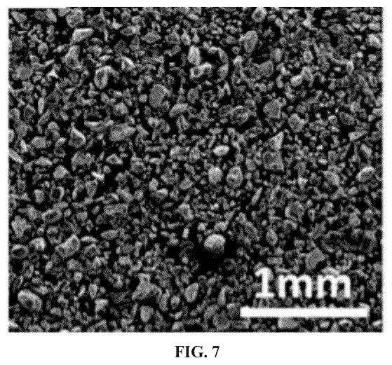

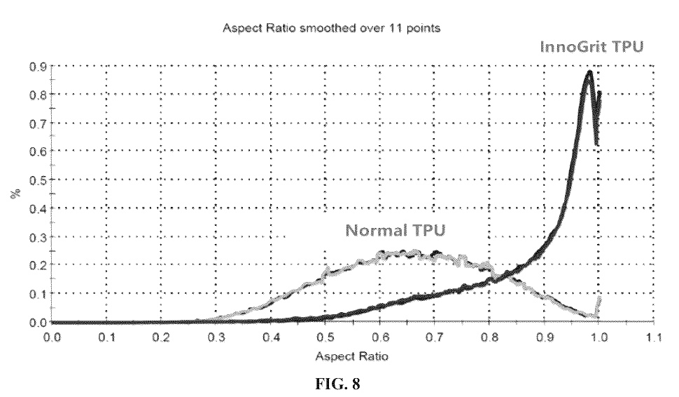

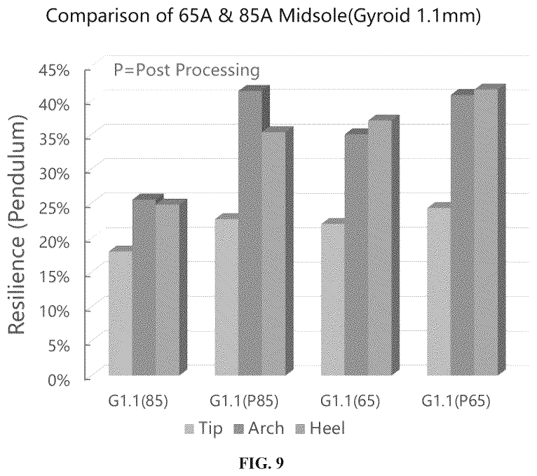

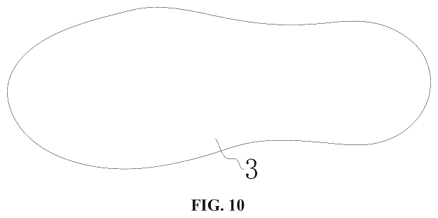

According to a first aspect, the present disclosure provides a method for preparing a breathable cushioned sole. Referring to FIG. 1 to FIG. 10,
the method for preparing a breathable cushioned sole may be used to prepare a sole with a specific cushioning function and breathable function, improving the comfort when the shoes are worn for a long term, and meeting use requirements when people wear the shoes for a long term, exercise at high intensity, are in harsh environments.

Specifically, the method for preparing a breathable cushioned sole in the present disclosure includes the following steps.

Prepare a breathable body 4 using an additive manufacturing method, where the breathable body 4 has a plurality of breathable channels that are connected with each other.

Prepare a support sole, where a flange that extends upwardly is formed on the support sole, to form a groove, and a support that extends upwardly is formed in a rear sole region of the support sole.

Prepare an outsole 1, and place the support sole on an upper surface of the outsole 1.

Place the breathable body 4 in the fore sole region, and connecting the breathable body 4 to the support sole in a mortise-tenon jointing manner.

Separately apply glue on an upper surface of the support and an outer periphery of the breathable body 4.

Place a midsole 2 on the breathable body 4 and the support, to enable the midsole 2 to be glued to the breathable body 4 and the support.

Connect the breathable body 4 to the midsole 2 in a mortise-tenon jointing manner.

According to the above technical solution, a plurality of lattices that are connected to each other and used for air circulation may be prepared. This is beneficial to breathability and perspiration, and beneficial to heat dissipation. Therefore, the forefoot is refreshing and comfortable, avoiding fungal growth or eczema of the skin due to sweat gathered in the forefoot. In addition, based on the structural design of the lattices, the breathable body 4 has a specific cushioning function. Therefore, impact on the forefoot is reduced when the forefoot hits the ground, thereby helping the forefoot to hit the ground safely and stably.

Further, the support, the breathable body 4, the midsole 2, and the outsole 1 may be quickly assembled based on the mortise-tenon jointing thereof. Further, based on features of the mortise-tenon jointing, once specifications of the support, the breathable body 4, the midsole 2, and the outsole 1 are not matched with each other, the staff can find and resolve the problem at first time, to avoid unqualified soles from entering a downstream process. This plays a specific role in correcting errors.

In addition, due to the structural design based on the breathable body, the support, and the midsole, different regions of the sole have different pressure-relieving effects while ensuring support strength, thereby adapting to foot shapes and meeting breathability/cushioning requirements of users in different sports scenarios or different sports states. In this way, the sole effectively meets individualized needs of different wearing objects, and thus has good flexibility and applicability.

For example, for a user with deformed feet, customized design can be performed based on the foot shape. Alternatively, when a patient is undergoing rehabilitation, flexibility can be provided based on sports states at different stages. Further, for athletes or people who stand (or walk) for a long time, supportability and resilience of the sole of the shoe can be designed, to enable the shoe to serve people better. In this way, the presence of shoes can be effectively reduced, thereby allowing people to carry out activities in a comfortable and natural posture.

In a specific implementation of the present disclosure, the additive manufacturing method includes the following steps.

Perform profiling design on the breathable body 4, to obtain a digital model, and design a running track based on the digital model.

Enable a three-dimensional (3D) printer to run according to the running track, and output a material on a substrate layer; and sinter the material, to form a support rib 400 through lamination and curing.

Repeat the above operations, to enable the support rib 400 to be cured layer by layer, and form the breathable body 4.

Specifically, the material is thermoplastic polyurethane elastomer rubber powders, with a particle size of a micron level. The sintering is conducted at 80° C. to 180° C.

The additive manufacturing method includes the following steps.

(1) Perform profiling design (a 3D structural sample of a minimal surface or 3D digital modeling of the midsole of the shoe) using computer 3D design software, to obtain a digital model; and import the profiling design into a 3D printer.

(2) Manufacture the 3D structural sample of the minimal surface by a 3D printer with selective laser sintering (SLS).

(3) Perform 3D printing for the 3D structural sample of the minimal surface or the midsole of the shoe through an SLS technology, where printing raw materials are TPU powders (or nylon powders in other manners); and perform scanning and irradiating on the powders layer by layer by a laser under the control of a computer, to sinter and bond the TPU powders, and then implement molding in a manner of stacking layer by layer.

(4) The TPU powders used for performing 3D printing on the midsole 2 of the shoe are powders with a particle size of a micron level, and the sintering is conducted at 80° C. to 180° C.

A thickness of a face structural wall of the support rib 400 of the breathable body 4 is 0.3 mm to 4 mm, and a side length of a unit structure is 3 mm to 20 mm.

For a 3D structural sample of the minimal surface used for printing a midsole module of the shoe, a deformation ranges between 10% and 80%, a resilience ranges between 20% and 80%, hardness (Shore A hardness, in accordance with standard ASTMD2240) of the material used in this example is between 60 A and 95 A, tensile strength is between 5 Mpa and 30 Mpa, an elongation at break is between 300% and 800%, and a tensile modulus is 10 Mpa to 200 Mpa. Materials with different hardness have different properties. In this embodiment, the TPU powders are preferentially sintered through the SLS laser sintering technology. Laser sintering is performed on the TPU powders through a special multi-point laser SLS printing process, so that products have performance advantages in terms of consistency, tensile strength Z, and material bending life.

In other embodiments, the sintering methods include, but are not limited to: fused filament fabrication (FFF), electron beam free-form fabrication (EBF), direct metal laser sintering (DMLS), electron beam melting (EMB), selective laser melting (SLM), selective heat sintering (SHS), selective laser sintering (SLS), lithophane 3D printing (PP), laminated object manufacturing (LOM), stereolithography (SLA), digital light processing (DLP), and various other 3D printing or additive manufacturing techniques known in the art.

The breathable body 4 prepared using the additive manufacturing method is obtained by performing one of 3D printing methods such as filament melt extrusion, microdroplet jetting of materials, flattening and melting of powders, ejection of binders, or lamination and curing of photosensitive resins on a thermoplastic rubber (TPR), a thermoplastic elastomer, a polyurethane elastomer (TPU), a nylon elastomer (TPAE), a polyester elastomer (TPEE), an EVA elastomer, and a silicone elastomer.

The breathable body 4 obtained by 3D printing has a three-dimensional lattice structure, on which flow channels for air circulation are formed. The flow channels are one or a combination of a polyhedron, a planar body, a cone-shaped body, a rhombohedron, star-shaped body, and a sphere.

In practical application, density of a breathable cushioning module may be adjusted by changing a structure, material, and diameter of a rod of the flow channel, and functions of air flow exchange and a cushioning function may be implemented by structural compression and deformation.

In the present disclosure, particles of the powders are melted and sintered by a 3D printing device, to enable a degree of sphericity of the material to be higher, thereby improving consistency of performance and surface quality of products.

In the method provided in the first aspect, the support rib 400 has an elongation at break of 755% and tensile strength of 10 MPa. The number of resistance to bend is 900,000. In a resilience test for the midsole 2, a regression rate of energy of the midsole 2 exceeds 40%.

A top surface and a bottom surface of a 3D printed breathable cushioning module both have a mortise-tenon structure, and are respectively connected to the midsole 2 and the outsole 1 in a mortise-tenon jointing manner and a gluing manner.

In this embodiment, the SLS technology is optionally used, and an energy radiation device includes a 3D printing device (including a laser transmitter, a F-theta lens, and a galvanometer system). The laser transmitter and galvanometer system are controlled to adjust energy of an output laser beam. For example, the laser transmitter is controlled to emit a laser beam with pre-set power, and to stop emitting the laser beam. For another example, the laser transmitter is controlled to increase and decrease the power of the laser beam. The f-theta lens is used to adjust a focusing position of the laser beam, and the galvanometer system is controlled to scan the laser beam in two-dimensional space of a printing reference surface in a container, and a light-curing material scanned by the laser beam is solidified, to form a corresponding pattern-curing layer.

A component platform of an SLS device is placed in a powder bed or a sintering chamber that is used to place a material to be cured, and used to adhere and accumulate a pattern-curing layer that is cured through irradiation. After powders are spread on a powder bed, a powder material to be cured is heated, by a thermostat facility in a printing device, to a temperature just below a sintering point of the powders, the laser of the energy radiation device tracks a three-dimensional model slice of the printing device, and the slice is copied onto the powder bed with a corresponding image, to enable the powder material to be heated above a melting point under laser irradiation, to be sintered, and then to be cured at a corresponding layer height of the slice. After a layer is constructed, the powder bed is lowered, a next corresponding slice is started to be constructed on the existing cured layer, and the above process is repeated until the printing is completed.

Compared to other materials, the performance advantages of the SLS process for printing the TPU material are as follows:
(1) Sphericity is good in the SLS process.
(2) In the SLS process, the elongation at break of the TPU material is 755% and the tensile strength is 10 Mpa. The number of resistance to bend is 900,000.
(3) In the SLS process, the regression rate of energy of the midsole 2 exceeds 40%, and performance of the midsole 2 exceeds performance of a material of a midsole 2 of another TPU.

In the present disclosure, the foaming method includes the following steps.

A foaming machine ejects a foaming material to form a polymer sub-blank.

Place the polymer sub-blank into a high pressure reactor.

Conduct preheating, inject a foaming agent, and after gas is diffused and balanced, rapidly releasing pressure to allow for foaming.

Place a special-shaped part after the forming into a secondary forming mold.

Specifically, the foaming agent is CO₂, N₂, or He. The foaming material is an EVA copolymer, a TPEE, a POE plastic, or a nylon elastomer.

Because of a complex structure, the outsole 1 is prepared by integrally foaming (a method for rapidly releasing pressure to allow for foaming). In this embodiment, a supercritical foaming process of the nylon elastomer is used as an example. A process flow of this forming process includes the following steps.

First, a raw material is ejected and molded into a polymer sub-blank, and the sub-blank is put into a high pressure reactor and preheated at a set saturation temperature; a specific amount of foaming agents such as CO₂ or N₂ are injected, and after gas is diffused and balanced, a pressure is rapidly released to allow for foaming, to obtain a semi-finished product of an outsole 1; and finally, the semi-finished product is put into a secondary forming mold for molding. In this process, appearance of an external support structure has no granular sensation, costs are low, and design and shaping are easy to be performed.

In other embodiments, the outsole 1 may be prepared using another foaming method, that is, a bead foaming method. A bead foaming technology is usually divided into two parts, namely, bead pre-foaming and bead molding. Bead pre-foaming stage: using a foaming technology of an anhydrous spouted bed. A small-sized polymer raw material is placed in the high pressure reactor, and then foaming beads with a high foaming rate and uniform foaming holes are prepared by controlling variables such as a CO₂ flow rate, a saturation temperature, a saturation pressure, and a pressure relief rate. By testing, an optimal CO₂ flow rate is about 0.012 m/s, an optimal saturation temperature is 155° C., an optimal saturation pressure is 11 Mpa, and an optimal pressure relief rate is 1.5 Mpa. Bead molding stage: The foaming beads are placed in the mold for preparing a foaming material with a complex shape or a special structure through sintering. This process has low costs and high efficiency, and the appearance has obvious granular sensation.

In an embodiment of the present disclosure, a thickness of the breathable cushioned sole is gradually increased along a direction from a fore sole to a heel. In this way, “rolling effect” during walking and exercise can be strengthened, a cushioning capability of the heel can be enhanced, stability of the forefoot during push-off can be improved, an ankle plantar flexion torque is reduced, an eversion moment and an extorsion moment can be reduced, so that the ankle joint is protected, thereby reducing probability of damage to a knee, reducing an amplitude of a muscle movement of a lower limb, and reducing muscle fatigue.

According to a second aspect, the present disclosure provides a breathable cushioned sole.

The breathable cushioned sole may be prepared using the method for preparing a breathable cushioned sole in the first aspect of the present disclosure. Therefore, breathable cushioned sole has technical effect the same as the method for preparing a breathable cushioned sole. To avoid repetition, details are not described herein again.

It should be noted that the sole provided in the second aspect of the present disclosure has a specific structure.

Referring to FIG. 1 to FIG. 4, the breathable cushioned sole includes an outsole 1 and a midsole 2. The outsole 1 is attached to a bottom surface of the midsole 2. The midsole 2 has an accommodation region, a flange that extends upwardly is formed on the midsole 2, and the flange of the midsole 2 may completely wrap the accommodation region. The accommodation region includes a fore sole region and a heel region. A breathable body 4 that is prepared using the additive manufacturing method is placed in the fore sole region. A support that extends upwardly and used to support the heel is formed in a heel region of the midsole 2. The breathable body 4 is disposed as a three-dimensional lattice structure formed by combining a plurality of support ribs 400. Different support ribs 400 are crosswise disposed to form flow channels for air circulation, where the plurality of flow channels run through each other.

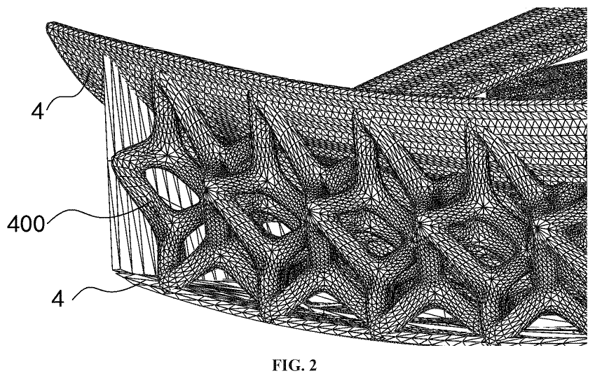

Referring to FIG. 1 and FIG. 2, the three-dimensional lattice structure has a plurality of lattices that are connected to each other and used for air circulation. This is beneficial to breathability and perspiration, and beneficial to heat dissipation. Therefore, the forefoot is refreshing and comfortable, avoiding fungal growth or eczema of the skin due to sweat gathered in the forefoot. In addition, based on the structural design of the lattices, the breathable body 4 has a specific cushioning function. Therefore, impact on the forefoot is reduced when the forefoot hits the ground, thereby helping the forefoot to hit the ground safely and stably.

Due to the structural design based on the breathable body, the support, and the midsole, different regions of the sole have different pressure-relieving effects while ensuring support strength, thereby adapting to foot shapes and meeting breathability/cushioning requirements of users in different sports scenarios or different sports states. In this way, the sole effectively meets individualized needs of different wearing objects, and thus has good flexibility and applicability.

In the present disclosure, a diameter of the support rib 400 is 0.3 mm to 0.5 mm. This ensures strength of the support rib 400, to enable the support rib 400 to have specific cushioning effect, and enable space for the flow channels to be large enough, thereby ensuring heat dissipation effect.

The three-dimensional lattice structure has the flow channels (including one or a combination a polyhedron, a planar body, a cone-shaped body, a rhombohedron, star-shaped body, and a sphere), and has specific elasticity. Functions of air flow exchange and a cushioning function may be implemented by structural compression and deformation. In practical application, density of a breathable cushioning module may be adjusted by changing the three-dimensional lattice structure, a type of the material, and a diameter of the support rib 400.

As a selection, a material of the breathable body 4 is any one of a light-curing resin material, a thermoplastic rubber, a thermoplastic elastomer, a polyurethane elastomer, a nylon elastomer, a polyester elastomer, an EVA elastomer, and an organic silicon elastomer. In view of this, the person skilled in the art may flexibly perform assembling based on the actual needs.

In the present disclosure, the sole further includes a protective frame. The protective frame includes a first support part adapted to the breathable body 4, a second support part adapted to the support, and a third support part disposed between the breathable body 4 and the support. In this way, not only the support effect of the sole can be improved, but also specific safety protection can be provided for the support and the breathable body 4.

In an embodiment of the present disclosure, the breathable body 4 is connected to the midsole 2 and the support sole in a mortise-tenon jointing manner, and two ends of the breathable body 4 are respectively glued to the support sole and the midsole 2; and the support is glued to the midsole 2. In this way, the breathable body 4, the midsole 2, and the support may be assembled quickly, and connection strength may be ensured by gluing, to prevent slippage.

In the present disclosure, at least two specifications of breathable holes are provided on the midsole 2, thereby assisting in perspiration and heat dissipation. A waterproof coating is disposed on a surface of the midsole 2, to play a specific waterproof role. In addition, different combinations of the breathable holes and combinations of the breathable waterproof coating may be disposed based on a wearing object, to implement waterproof and breathable functions of the midsole 2.

In an embodiment of the present disclosure, a side, in contact with the ground, of the outsole 1 is a contact surface, where a plurality of rows of claw nails 5 are disposed on the contact surface, and the claw nails 5 spread throughout the contact surface. In this way, a weight of the outsole 1 can be significantly reduced while a stable grip is provided.

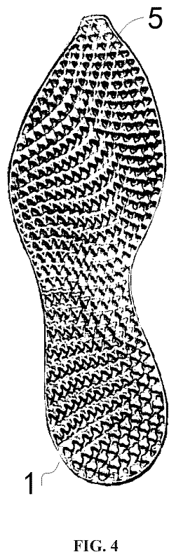

Referring to FIG. 4, the claw nails 5 all are in a triangular shape. By means of specially designed triangular nail-shaped resin particles, effective drainage on a slippery road can be ensured, and friction performance on the slippery road can be significantly improved.

Further, each row of claw nails 5 include a dyadic segment and a left-falling shaped segment and a right-falling shaped segment that is connected to the left-falling shaped segment. The left-falling shaped segment extends toward the outside of the foot and is in a left-falling shape, and the right-falling shaped segment extends toward the inside of the foot and is in a right-falling shape. In the heel region, each row of claw nails 5 are disposed obliquely, where the direction from a fore sole to a heel is a height direction. In each row of claw nails 5, positions of the claw nails 5 close to the outside of the foot are lower than positions of the claw nails 5 close to the inside of the foot. By means of specially arranged claw nails 5, effective drainage on the slippery road can be ensured, and friction performance on the slippery road can be significantly improved.

In the present disclosure, the outsole 1 is made of a double-layer material compounded with polyester resin fibers and resin particles through a method for adhering a shoe patterns with base cloth.

In the present disclosure, at least two avoidance grooves are provided on the flange of the support sole, and the avoidance grooves are provided at an outer position of the sole. In this way, the foot can comfortably move while wrapping and stability for the foot are ensured.

According to a third aspect of the present disclosure, a shoe is provided.

Specifically, the shoe includes the sole as described in the second aspect. Therefore, the shoe has technical effect the same as the sole.

It should be noted that the shoe further includes a sole that is prepared using the method for preparing a breathable cushioned sole in the first aspect of the present disclosure. Therefore, breathable cushioned sole has technical effect the same as the method for preparing a breathable cushioned sole. To avoid repetition, details are not described herein again.

The above are the implementations listed in the present disclosure, but the present disclosure is not limited to the above optional implementations. Those skilled in the art can obtain various implementations by any combination of the above implementations, and anyone can obtain other various implementations under the enlightenment of the present disclosure.

1. A method for preparing a breathable cushioned sole, comprising:
preparing an outsole (1);
preparing a midsole (2) using a foaming method, wherein a flange that extends upwardly is formed on the midsole (2), a region within the flange is defined as an accommodation region; and the accommodation region comprises a fore sole region and a heel region, and a support that extends upwardly is formed in a rear sole region of the midsole (2);
preparing a breathable body (4) using an additive manufacturing method, wherein the breathable body (4) has a plurality of breathable channels that are connected with each other;
placing the breathable body (4) in the fore sole region, and connecting the breathable body (4) to the midsole (2) in a mortise-tenon jointing manner;
separately applying glue on an upper surface of the support and an outer periphery of the breathable body (4); and
placing a lasting insole (3) on the breathable body (4) and the support, to enable the lasting insole (3) to be glued to the breathable body (4) and the support.

2. The method for preparing a breathable cushioned sole according to claim 1, wherein the additive manufacturing method comprises:
performing profiling design on the breathable body (4), to obtain a digital model, and designing a running track based on the digital model;
enabling a three-dimensional (3D) printer to run according to the running track, and outputting a material on a substrate layer; and sintering the material, to form a support rib (400) through lamination and solidification; and
repeating the above operations, to enable the support rib (400) to be solidified layer by layer, and form the breathable body (4).

3. The method for preparing a breathable cushioned sole according to claim 2, wherein the material is thermoplastic polyurethane elastomer rubber powders, with a particle size of a micron level.

4. The method for preparing a breathable cushioned sole according to claim 2, wherein the sintering is conducted at 80° C. to 180° C.

5. The method for preparing a breathable cushioned sole according to claim 1, wherein the foaming method comprises:
ejecting, by a foaming machine, a foaming material, to form a polymer sub-blank;
placing the polymer sub-blank into a high pressure reactor;
conducting preheating, injecting a foaming agent, and after gas is diffused and balanced, rapidly releasing pressure to allow for foaming; and
placing a special-shaped part after the foaming into a forming mold to allow for forming, to obtain the midsole (2).

6. The method for preparing a breathable cushioned sole according to claim 5, wherein the foaming agent is CO₂, N₂, or He.

7. The method for preparing a breathable cushioned sole according to claim 5, wherein the foaming material is at least one of supercritical foaming nylon, thermoplastic polyurethane (TPU), ethyl vinyl acetate (EVA), or polyether block amide (PEBA).

8. The method for preparing a breathable cushioned sole according to claim 1, wherein an overall thickness of the breathable cushioned sole is gradually increased along a direction from a fore sole to a heel.

9. A breathable cushioned sole, prepared using a method for preparing a breathable cushioned sole, comprising:
preparing an outsole (1);
preparing a midsole (2) using a foaming method, wherein a flange that extends upwardly is formed on the midsole (2), a region within the flange is defined as an accommodation region; and the accommodation region comprises a fore sole region and a heel region, and a support that extends upwardly is formed in a rear sole region of the midsole (2);
preparing a breathable body (4) using an additive manufacturing method, wherein the breathable body (4) has a plurality of breathable channels that are connected with each other;
placing the breathable body (4) in the fore sole region, and connecting the breathable body (4) to the midsole (2) in a mortise-tenon jointing manner;
separately applying glue on an upper surface of the support and an outer periphery of the breathable body (4); and
placing a lasting insole (3) on the breathable body (4) and the support, to enable the lasting insole (3) to be glued to the breathable body (4) and the support.

10. The breathable cushioned sole according to claim 9, wherein the additive manufacturing method comprises:
performing profiling design on the breathable body (4), to obtain a digital model, and designing a running track based on the digital model;
enabling a three-dimensional (3D) printer to run according to the running track, and outputting a material on a substrate layer; and sintering the material, to form a support rib (400) through lamination and solidification; and
repeating the above operations, to enable the support rib (400) to be solidified layer by layer, and form the breathable body (4),
wherein the material is thermoplastic polyurethane elastomer rubber powders, with a particle size of a micron level.

11. The breathable cushioned sole according to claim 9, wherein the additive manufacturing method comprises:
performing profiling design on the breathable body (4), to obtain a digital model, and designing a running track based on the digital model;
enabling a three-dimensional (3D) printer to run according to the running track, and outputting a material on a substrate layer; and sintering the material, to form a support rib (400) through lamination and solidification; and
repeating the above operations, to enable the support rib (400) to be solidified layer by layer, and form the breathable body (4),
wherein the sintering is conducted at 80° C. to 180° C.

12. The breathable cushioned sole according to claim 9, wherein the foaming method comprises:
ejecting, by a foaming machine, a foaming material, to form a polymer sub-blank;
placing the polymer sub-blank into a high pressure reactor;
conducting preheating, injecting a foaming agent, and after gas is diffused and balanced, rapidly releasing pressure to allow for foaming; and
placing a special-shaped part after the foaming into a forming mold to allow for forming, to obtain the midsole (2),
wherein the foaming agent is CO₂, N₂, or He.

13. The breathable cushioned sole according to claim 9, wherein the foaming method comprises:
ejecting, by a foaming machine, a foaming material, to form a polymer sub-blank;
placing the polymer sub-blank into a high pressure reactor;
conducting preheating, injecting a foaming agent, and after gas is diffused and balanced, rapidly releasing pressure to allow for foaming; and
placing a special-shaped part after the foaming into a forming mold to allow for forming, to obtain the midsole (2),
wherein the foaming material is at least one of supercritical foaming nylon, thermoplastic polyurethane (TPU), ethyl vinyl acetate (EVA), or polyether block amide (PEBA).

14. The breathable cushioned sole according to claim 9, wherein an overall thickness of the breathable cushioned sole is gradually increased along a direction from a fore sole to a heel.

15. A breathable cushioned shoe, comprising a breathable cushioned sole prepared using a method for preparing a breathable cushioned sole, the method for preparing a breathable cushioned sole comprising:
preparing an outsole (1);
preparing a midsole (2) using a foaming method, wherein a flange that extends upwardly is formed on the midsole (2), a region within the flange is defined as an accommodation region; and the accommodation region comprises a fore sole region and a heel region, and a support that extends upwardly is formed in a rear sole region of the midsole (2);
preparing a breathable body (4) using an additive manufacturing method, wherein the breathable body (4) has a plurality of breathable channels that are connected with each other;
placing the breathable body (4) in the fore sole region, and connecting the breathable body (4) to the midsole (2) in a mortise-tenon jointing manner;
separately applying glue on an upper surface of the support and an outer periphery of the breathable body (4); and
placing a lasting insole (3) on the breathable body (4) and the support, to enable the lasting insole (3) to be glued to the breathable body (4) and the support.

16. The breathable cushioned shoe according to claim 15, wherein the additive manufacturing method comprises:
performing profiling design on the breathable body (4), to obtain a digital model, and designing a running track based on the digital model;
enabling a three-dimensional (3D) printer to run according to the running track, and outputting a material on a substrate layer; and sintering the material, to form a support rib (400) through lamination and solidification; and
repeating the above operations, to enable the support rib (400) to be solidified layer by layer, and form the breathable body (4),
wherein the material is thermoplastic polyurethane elastomer rubber powders, with a particle size of a micron level.

17. The breathable cushioned shoe according to claim 15, wherein the additive manufacturing method comprises:
performing profiling design on the breathable body (4), to obtain a digital model, and designing a running track based on the digital model;
enabling a three-dimensional (3D) printer to run according to the running track, and outputting a material on a substrate layer; and sintering the material, to form a support rib (400) through lamination and solidification; and
repeating the above operations, to enable the support rib (400) to be solidified layer by layer, and form the breathable body (4)
wherein the sintering is conducted at 80° C. to 180° C.

18. The breathable cushioned shoe according to claim 15, wherein the foaming method comprises:
ejecting, by a foaming machine, a foaming material, to form a polymer sub-blank;
placing the polymer sub-blank into a high pressure reactor;
conducting preheating, injecting a foaming agent, and after gas is diffused and balanced, rapidly releasing pressure to allow for foaming; and
placing a special-shaped part after the foaming into a forming mold to allow for forming, to obtain the midsole (2),
wherein the foaming agent is CO₂, N₂, or He.

19. The breathable cushioned shoe according to claim 15, wherein the foaming method comprises:
ejecting, by a foaming machine, a foaming material, to form a polymer sub-blank;
placing the polymer sub-blank into a high pressure reactor;
conducting preheating, injecting a foaming agent, and after gas is diffused and balanced, rapidly releasing pressure to allow for foaming; and
placing a special-shaped part after the foaming into a forming mold to allow for forming, to obtain the midsole (2),
wherein the foaming material is at least one of supercritical foaming nylon, thermoplastic polyurethane (TPU), ethyl vinyl acetate (EVA), or polyether block amide (PEBA).

20. The breathable cushioned shoe according to claim 15, wherein an overall thickness of the breathable cushioned sole is gradually increased along a direction from a fore sole to a heel.
